(19) United States
(12) Patent Application Publication
(10) Pub. No.: US 2025/0127594 A1
(43) Pub. Date: Apr. 24, 2025

(54) DEVICES, INSTRUMENTS, SYSTEMS, AND METHODS FOR PREPARING PROSTHESES

(71) Applicant: Bruce G. VALAURI, Roslyn, NY (US)

(72) Inventor: Bruce G. VALAURI, Roslyn, NY (US)

(21) Appl. No.: 18/920,002

(22) Filed: Oct. 18, 2024

Related U.S. Application Data
(60) Provisional application No. 63/591,598, filed on Oct. 19, 2023.

(51) Int. Cl. A61C 8/00; A61C 13/00

(52) U.S. Cl. CPC A61C 8/0089; A61C 13/0006

(57) ABSTRACT

A rotary instrument including a body with a first end and a second end. A tip connects to and extends from the first end of the body, the tip having a first end and a second end. The instrument further includes a protrusion extending circumferentially from an outer surface of at least a portion of the body. Methods and systems for preparing a prosthesis for insertion using the rotary instrument are also disclosed.

### CROSS-REFERENCE TO RELATED APPLICATION

This application claims priority benefit of U.S. provisional application No. 63/591,598 filed Oct. 19, 2023, entitled DEVICES, INSTRUMENTS, SYSTEMS, AND METHODS FOR PREPARING PROSTHESES, which is hereby incorporated herein by reference in its entirety.

### TECHNICAL FIELD

The present disclosure relates generally to the preparation of prostheses. More specifically, but not exclusively, the present disclosure relates to devices, instruments, systems and methods for the removal of excess materials from dental prostheses.

### BACKGROUND

Patients require prostheses for a wide range of medical conditions and/or body parts. It is common for a prosthesis to be made of multiple components which must be attached to each other. Generally, a prosthesis will therefore include components for attaching the prosthesis to a patient. In some cases, the process of combining these components is imperfect, leaving behind excess material which may obstruct the attachment between the prosthesis and the patient. This can result in the prosthesis attaching improperly or not at all, which may affect the function of the prosthesis and thus also the patient.

In the case of dental prosthetics, a prosthesis will often include an attachment means in the form of a coping. The coping may be intended to attach to an abutment which has been implanted into the patient's mouth to secure the prosthesis within the mouth. In some cases, during manufacturing and/or preparation of the prosthesis, a restorative material such as an acrylic resin (e.g., “flash”), an adhesive, or a metal casting may be used to secure the coping within the prosthesis. When this process is performed, excess acrylic resin may be left behind which obstructs the connection between the coping and the abutment. This obstruction may affect the function of the prosthesis which may in turn negatively impact the patient.

Accordingly, there is a need for improved devices, instruments, systems, and methods which permit effective preparation of prosthetic attachment means.

### SUMMARY

The present disclosure is directed toward devices, instruments, systems, and methods for preparing a prosthesis for insertion.

The present disclosure provides, in a first aspect, a rotary instrument including a body with a first end and a second end. A tip connects to and extends from the first end of the body, the tip having a first end and a second end. The instrument further includes a protrusion extending circumferentially from an outer surface of at least a portion of the body.

The present disclosure provides, in a second aspect, a method for preparing a prosthesis for insertion including obtaining a prosthesis having an implant coping and excess material, obtaining an instrument having a tip and a first portion, and inserting the tip of the instrument into the implant coping of the prosthesis, such that the tip is received within a cavity of the implant coping, and such that the first portion contacts the excess material. The method further includes rotating the instrument such that the first portion removes at least a portion of the excess material.

The present disclosure provides, in a third aspect, a system for preparing a prosthesis for insertion including an instrument having a tip connected to a body, the body having an outer surface and a removing surface, the removing surface extending along at least a portion of the outer surface of the body, and a prosthesis having an implant coping and excess material, the excess material contacting the implant coping, and the implant coping having an inner surface. The tip has a smooth outer surface and is dimensioned to be inserted into the implant coping such that the tip contacts the inner surface, and the removing surface is configured to contact the excess material when the tip is in contact with the inner surface. The instrument is configured to be rotated such that the removing surface removes at least a portion of the excess material.

These and other objects, features, and advantages of this disclosure will become apparent from the following detailed description of the various aspects of the disclosure taken in conjunction with the accompanying drawings.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure.

FIG. 1 depicts a first perspective view of an instrument, in accordance with an aspect of the present disclosure;

FIG. 2 depicts a second perspective view of the instrument of FIG. 1, in accordance with an aspect of the present disclosure;

FIG. 3 depicts a first side view of the instrument of FIG. 1, in accordance with an aspect of the present disclosure;

FIG. 4 depicts second side view of the instrument of FIG. 1, in accordance with an aspect of the present disclosure;

FIG. 5 depicts a cross-sectional view of the instrument of FIG. 1 taken along line 5--5 of FIG. 4, in accordance with an aspect of the present disclosure;

FIG. 6 depicts a cross-sectional view of the instrument of FIG. 1 taken along line 6--6 of FIG. 3, in accordance with an aspect of the present disclosure;

FIG. 7 depicts a top view of the instrument of FIG. 1, in accordance with an aspect of the present disclosure;

FIG. 8 depicts a bottom view of the instrument of FIG. 1, in accordance with an aspect of the present disclosure;

FIG. 9 depicts a first, top perspective view of an implant coping, prior to being inserted into a prosthesis, in accordance with an aspect of the present disclosure;

FIG. 10 depicts a second, bottom perspective view of the implant coping of FIG. 9, prior to being inserted into a prosthesis, in accordance with an aspect of the present disclosure;

FIG. 11 depicts an implant abutment, prior to being inserted into a patient's mouth, in accordance with an aspect of the present disclosure;

FIG. 12 depicts a side view of the implant coping of FIG. 9 and the implant abutment of FIG. 11, in accordance with an aspect of the present disclosure;

FIG. 13 depicts a side view of the implant coping of FIG. 9 receiving the implant abutment of FIG. 11, in accordance with an aspect of the present disclosure;

FIG. 14 depicts a perspective view of the implant coping of FIG. 9 received within a prosthesis and having excess material to be removed, in accordance with an aspect of the present disclosure;

FIG. 15 depicts a perspective view of the prosthesis of FIG. 14 receiving the instrument of FIG. 1 within a cavity of the implant coping of FIG. 9, in accordance with an aspect of the present disclosure;

FIG. 16 depicts a perspective view of the prosthesis of FIG. 14 after having the excess material removed from the implant coping of FIG. 9, in accordance with an aspect of the present disclosure;

FIG. 17 depicts a cross-sectional view of the prosthesis of FIG. 14 receiving the instrument of FIG. 1 within the cavity of the implant coping of FIG. 9, taken along line 17--17 of FIG. 14, in accordance with an aspect of the present disclosure;

FIG. 18 depicts a perspective view of a plurality of the implant abutments of FIG. 11 implanted in an upper jaw of a first patient, in accordance with an aspect of the present disclosure;

FIG. 19 depicts a perspective view of a plurality of the implant abutments of FIG. 11 implanted in a lower jaw of the first patient, in accordance with an aspect of the present disclosure;

FIG. 20 depicts a perspective view of prostheses received within a mouth of the first patient and engaging the implant abutments of FIGS. 18 and 19, in accordance with an aspect of the present disclosure;

FIG. 21 depicts a perspective view of a plurality of the implant abutments of FIG. 11 implanted in an upper jaw and lower jaw of a second patient, in accordance with an aspect of the present disclosure;

FIG. 22 depicts a perspective view of a first prosthesis coupled to the plurality of abutments of FIG. 21 in the upper jaw of the second patient, in accordance with an aspect of the present disclosure; and

FIG. 23 depicts a perspective view of a second prosthesis coupled to the plurality of implant abutments of FIG. 21 in the lower jaw of the second patient in accordance with an aspect of the present disclosure.

### DETAILED DESCRIPTION

Generally stated, disclosed herein are devices, instruments, systems, and methods for preparing dental prostheses. Further, methods for using the devices, instruments, and systems for preparing dental prosthetics for insertion are discussed.

Positions or directions (e.g., upper or lower) may be used herein with reference to anatomical structures or surfaces. For example, as the current devices, systems, instrumentation and methods are described herein with reference to use with dental prostheses, the anatomy of the mouth may be used to describe the surfaces, positions, directions or orientations of the devices, implants, systems, instrumentation and methods. Further, the devices, systems, instruments and methods, and the aspects, components, features and the like thereof, disclosed herein are described with respect to use with dental prosthesis for brevity purposes. However, as the aspects of the present disclosure are relevant to the preparation of prosthetics for use in other areas of the body, it is hereby expressly contemplated that the devices, systems, instrumentation and methods, and the aspects, components, features and the like thereof, described and/or illustrated herein may be changed, varied, modified, reconfigured, or otherwise altered for use or association with the preparation of prostheses of and/or for use with other parts of the body for a same or similar purpose without departing from the spirit and scope of the disclosure. For example, the devices, instruments, systems and methods, and the aspects, components, features and the like thereof, described herein with respect to dental prosthesis of the mouth may also be applied to prosthesis for various limbs and extremities. It should thus be understood that the systems, methods, devices and instruments disclosed herein may be used with respect to other prosthetics of and/or for use in different parts of the body.

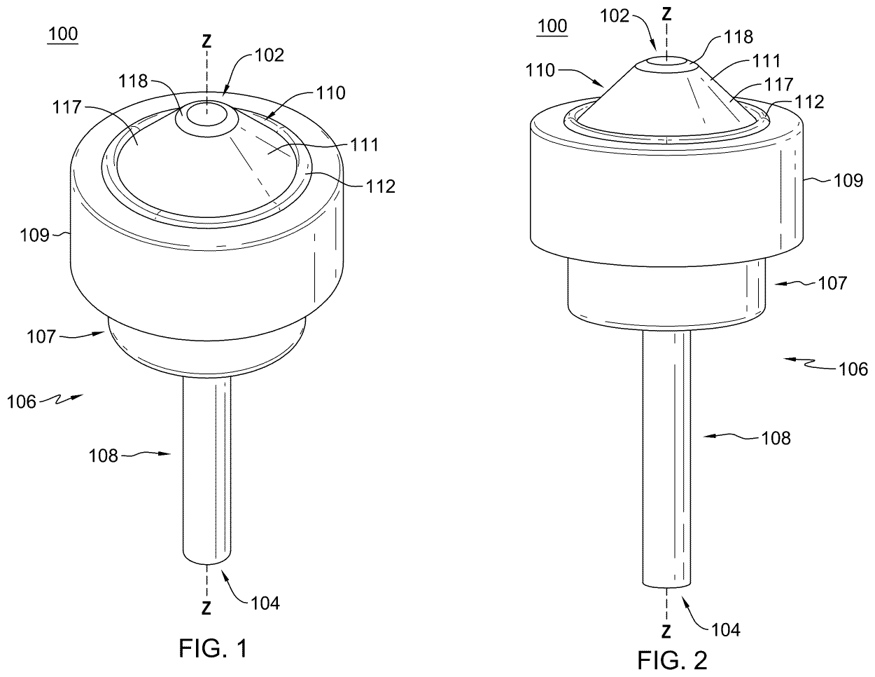

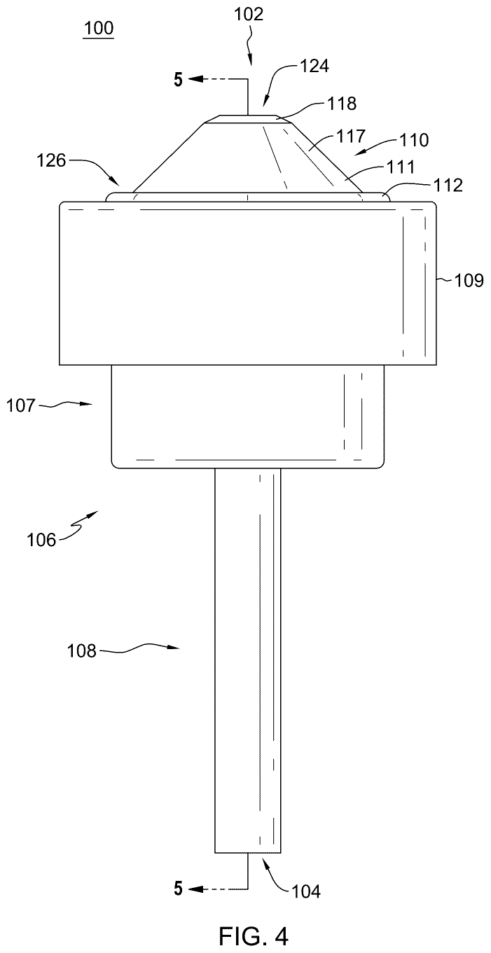

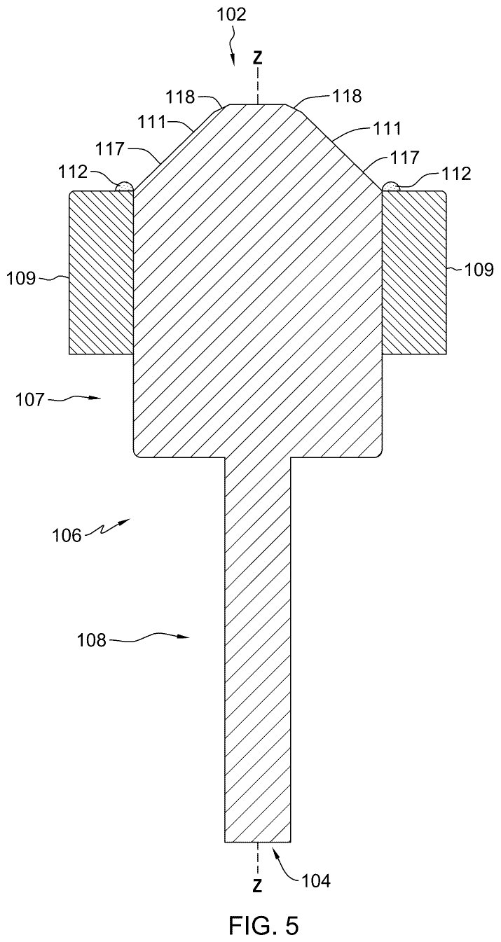

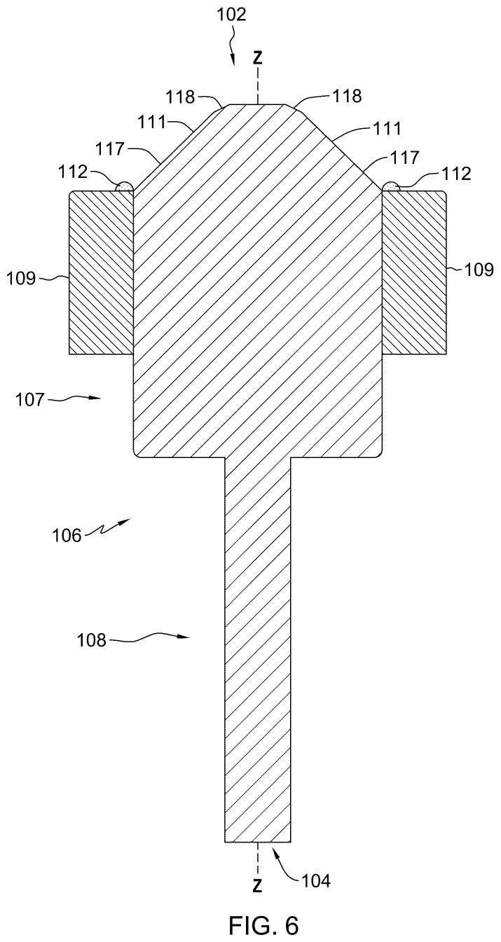

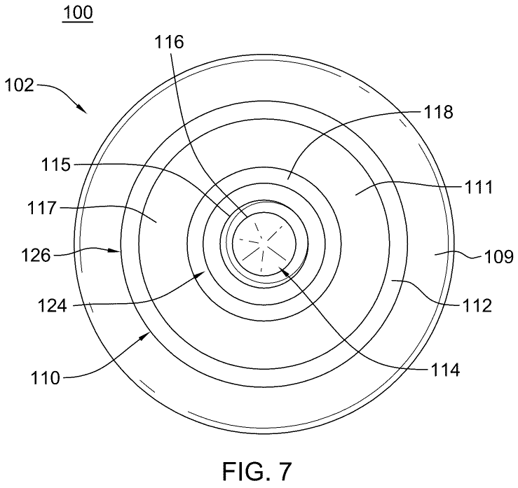

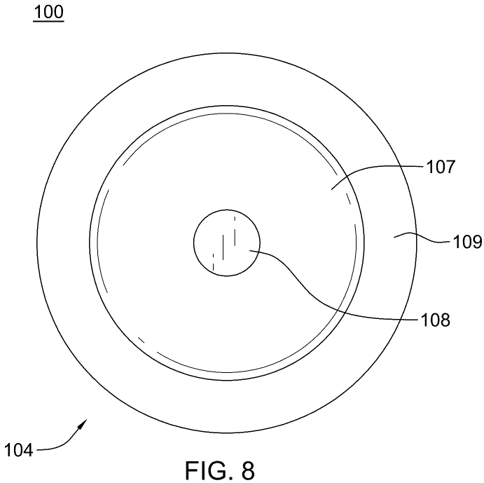

Referring to the drawings, wherein like reference numerals are used to indicate like or analogous components throughout the several views, and with particular reference to FIGS. 1-23, devices, instruments, systems, and methods of using the devices, instruments, and systems for preparing prostheses for use are shown. Specifically, the methods may include procedure(s) for removing excess material from dental prosthetics prior to the prosthetic being used by a patient and/or inserted into a mouth of a patient.

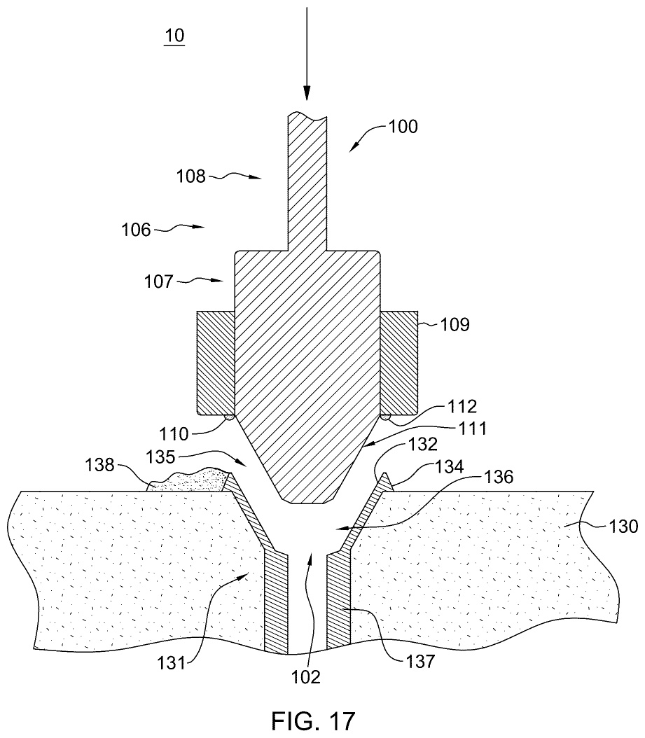

As described in more detail below and shown in FIGS. 1-23, a system 10 for preparing prostheses may include an instrument 100 and a prosthesis 130, 230, 332, 334 having at least one implant coping 131. The implant coping 131 may be inserted into the prosthesis 130, 230, 332, 334 and further may be secured thereto via a restorative material such as an acrylic resin (e.g., “flash”), an adhesive, or a metal casting. Upon insertion of the implant coping 131 into the prosthesis 130, 230, 332, 334 excess material 138 may be created and/or formed around a portion of the implant coping 131. For example, as discussed below, there may be a prosthesis 130, 230, 332, 334 with excess material 138 (e.g., excess acrylic resin) which must be removed to facilitate a desired connection and/or engagement between the implant coping 131 and an implant abutment 140. It is an object of the present disclosure that such excess material 138 may be removed through operation of the system 10 as described below (FIG. 17). The implant abutment 140 to which the implant coping 131 is to engage may be located and/or implanted into a patient, for example, in a mouth of the patient. The implant abutment 140 may be implanted directly into the patient's mouth or, alternatively, may be connected to an implant base 149 which has been implanted into the patient's mouth.

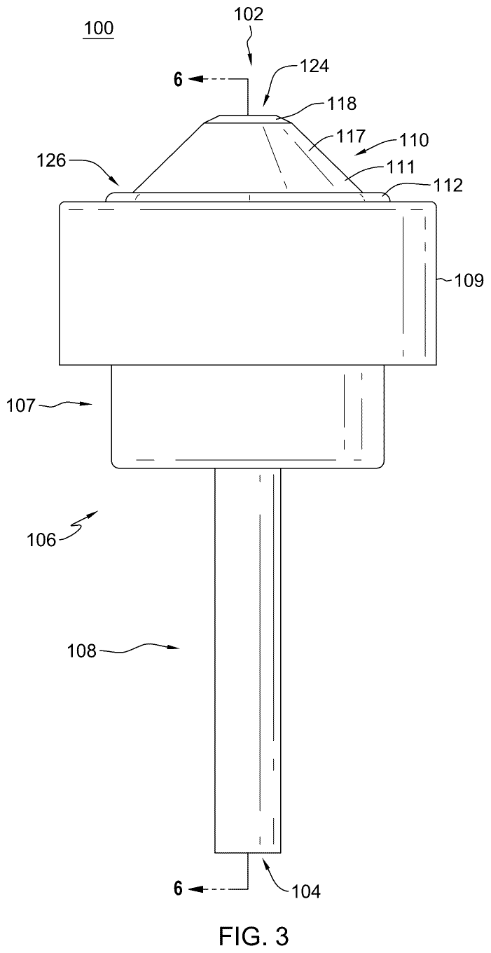

With continued reference to FIGS. 1-8, the instrument 100 for removing the excess material 138 is shown. The instrument 100 may include a tip 110 and a body 106 extending between a first end 102 of the instrument 100 and a second end 104 of the instrument 100. The tip 110 may, for example, extend from the first end 102 to the body 106, and the body 106 may extend from the tip 110 to the second end 104. The body 106 may further include a first portion 107 and a second portion 108. The first portion 107 of the body 106 may extend from the tip 110 to the second portion 108 and the second portion 108 of the body 106 may extend from the first portion 107 to the second end 104. In an embodiment, the tip 110, the first portion 107 and the second portion 108 may be longitudinally aligned along an axis Z extending through a center of the body 106 and the tip 110 from the first end 102 to the second end 104, as shown in FIGS. 1-2 and 5-6. In some embodiments, the first portion 107, the second portion 108, and/or the tip 110 may be radially symmetrical. In embodiments were all of the first portion 107, the second portion 108, and the tip 110 are symmetrical and aligned along the axis Z, the front and side views may be substantially identical, as in FIGS. 3-6.

The first portion 107 of the body 106 may include a cutting and/or grinding surface 109 for cutting and/or grinding the excess material 138, as described in more detail below. The cutting surface 109 may have, for example, a rough or textured surface. In some embodiments, the cutting surface 109 may be, for example, fluted. The cutting surface 109 may, for example, extend radially outward from a portion of the first portion 107, as shown in FIGS. 1-8. However, in other embodiments, not shown, the cutting surface 109 may extend radially outward from all of the first portion 109. The cutting surface 109 may also extend circumferentially around the first portion 107 or around only a portion thereof. In embodiments where the cutting surface 109 extends radially from only a portion of the first portion 107, the cutting surface 109 may be disposed towards the tip 110 of the instrument 100 to ensure the cutting surface 109 contacts the excess material 138 during operation of the instrument 100 and/or the system 10. The cutting surface 109 may be integral to and/or monolithically formed (i.e., of one-piece construction) with the first portion 107 or, alternatively, the cutting surface 109 and the first portion 107 may be formed from a plurality of components that are coupled (e.g., rigidly coupled) together.

The second portion 108 of the body 106 may include a means for attaching the instrument 100 to another tool for use. In an embodiment shown in FIGS. 1-4, the second portion may include a straight rod, shaft, and/or shank configured for engagement in and/or with a rotary tool (not shown). The rotary tool may be, for example, a drill, powered screwdriver, or like rotatably driven tool. The rotary tool may engage the rod, shaft, and/or shank to hold and/or grasp the instrument 100 during operation of the system 10. For example, the rotary tool may engage the rod, shaft, and/or shank of the second portion 108 prior to and during a rotation of the instrument 100, as described in more detail below and which will not be described here for brevity's sake. In an embodiment, the second end 104 of the instrument 100 may be flat. In other embodiments, the second end 104 may have any shape which permits engagement of the instrument 100 with a rotary tool.

The tip 110 may have a truncated cone or frustum shape as shown in FIGS. 1-6. In other embodiments not shown, the tip 110 may be substantially cylindrical. The shape of the tip 110 may permit insertion of the tip 110 into a cavity 136 of the implant coping 131. In an example, the tip 110 may include a narrow end 124, a wide end 126, and a smooth outer surface 111 extending from the narrow end 124 to the wide end 126. The narrow end 124 may be located at and/or disposed towards the first end 102 of the instrument 100, and the wide end 126 may be disposed towards and/or contact the body 106. In an embodiment, the wide end 126 may contact and/or abut the first portion 107 of the body 106.

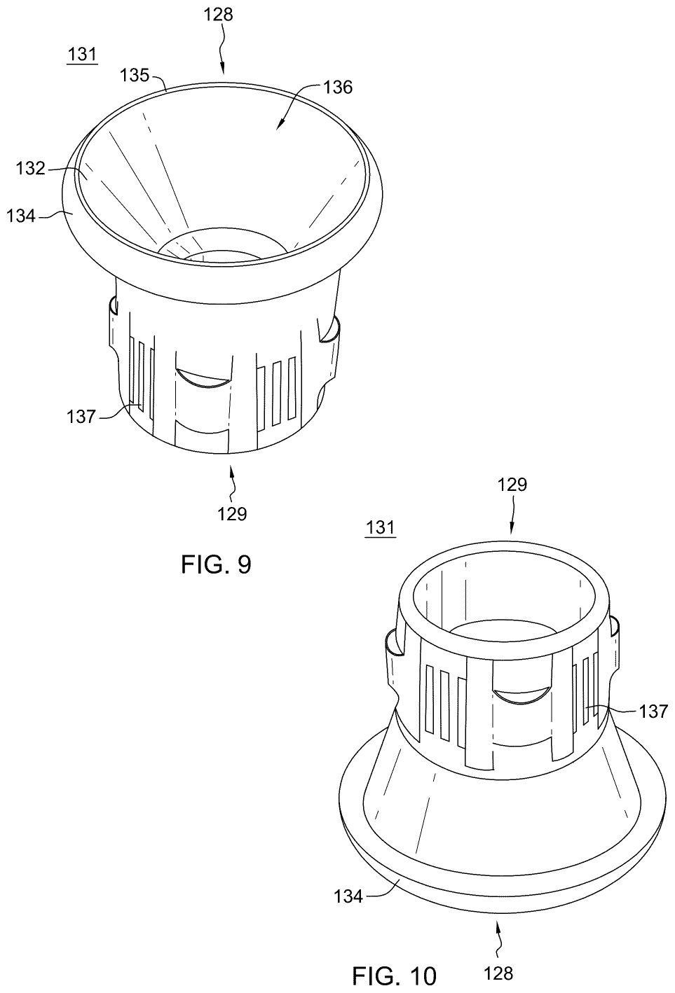

The tip 110 may be configured and/or sized and shaped to engage with the implant coping 131 during operation of the instrument 100 and/or the system 10. The smooth outer surface 111 of the tip 110 may therefore be configured and/or sized and shaped to enable the tip 110 to slide and/or glide along an inner surface 132 of the implant coping 131 during operation of the system 10 (e.g., during a rotation of the instrument 100). The shape of the tip 110 may further be configured, adjusted, and/or modified depending on the shape of the corresponding cavity 136. For example, as noted above, the tip 110 may have a frustoconical shape where the cavity 136 is frustoconical, or the tip 110 may have a cylindrical shape where the corresponding cavity 136 is cylindrical. In some embodiments, the tip 110 may be flat at the first end 102. In other embodiments, the tip 110 may include an aperture 114 for example, at the first end 102 of the tip 110 (FIG. 7). In some such embodiments, the aperture 114 may be threaded. In other such embodiments, the aperture 114 may lack threading. Due to the shape of the cavity 136 (FIG. 9), the smooth outer surface 111 may in some embodiments include, for example, a first surface portion 117 and a bevel 118 to permit proper engagement between the tip 110 and the cavity 136. In such an embodiment, the first surface portion 117 may extend from the wide end 126 to the bevel 118, and the bevel 118 may extend from the first surface portion 117 to the narrow end 124. In other embodiments, the tip 110 may lack the bevel 108 (FIG. 17).

The tip 110 may further include a shelf, rim, and/or lip 112 as shown in FIGS. 1-7. The lip 112 may extend circumferentially around the tip 110, for example, along an edge of the wide end 126. In an embodiment, the lip 112 may contact the first portion 107 of the body 106 and/or the cutting surface 109. The lip 112 may be configured and/or sized and shaped to receive a rim 134 of the coping 131 during operation of the instrument 100 and/or the system 10 such that the cutting surface 109 may avoid contact with the rim 134 (and the implant coping 131, generally). Like the smooth outer surface 111, the lip 112 may be, for example, smooth such that the lip 112 may slide and/or glide over and/or along the rim 134 during operation of the system 10 (e.g., during a rotation of the instrument 100). In this way, the lip 112 may protect the rim 134 from damage and/or wear during a removal of the excess material 138.

Turning to FIGS. 9-10, an embodiment of the implant coping 131 is shown prior to being inserted into a prosthesis 130, 230, 332, 334. The implant coping 131 may have a first end 128 and a second end 129. The coping 131 may further include an inner surface 132, a rim 134, a cavity 136, and an anchor portion 137. The rim 134 may be located at and/or contacting the first end 128 of the coping 131. The rim 134 may extend circumferentially around the coping 131 at the first end 128. The rim 134 may bound an opening 135 to the cavity 136, and the inner surface 132 may bound the cavity 136 itself. The cavity 136 may extend into the coping 131 from the first end 128 toward the second end 129. The cavity 136 may be configured and/or sized and shaped to receive the implant abutment 140 and/or the tip 110 of the instrument 100, for example, after the anchor portion 137 has been inserted into the prosthesis 130, 230, 332, 334. The anchor portion 137 may be located at and/or contacting the second end 129. The anchor portion 137 may extend from the second end 129 toward the first end 128 of the coping 131 to a position adjacent to a bottom of the cavity 136. The anchor portion 137 may engage with and/or be embedded within the prosthesis 130, 230, 332, 334. In an embodiment, the anchor portion 137 may be inserted into the prosthesis 130, 230, 332, 334 and secured therein by using a restorative material such as, for example, an acrylic resin. In other embodiments, the anchor portion 137 may be secured within the prosthesis 130, 230, 332, 334 by using an adhesive material or a metal casting.

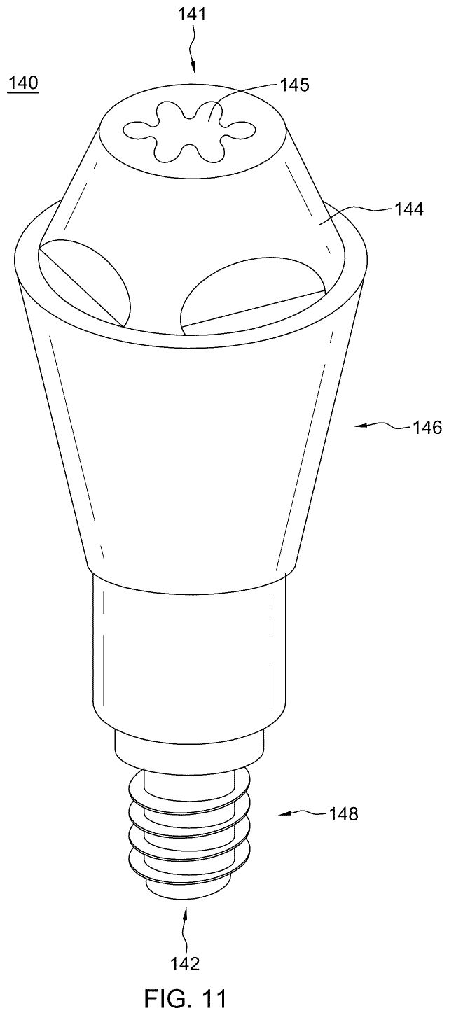

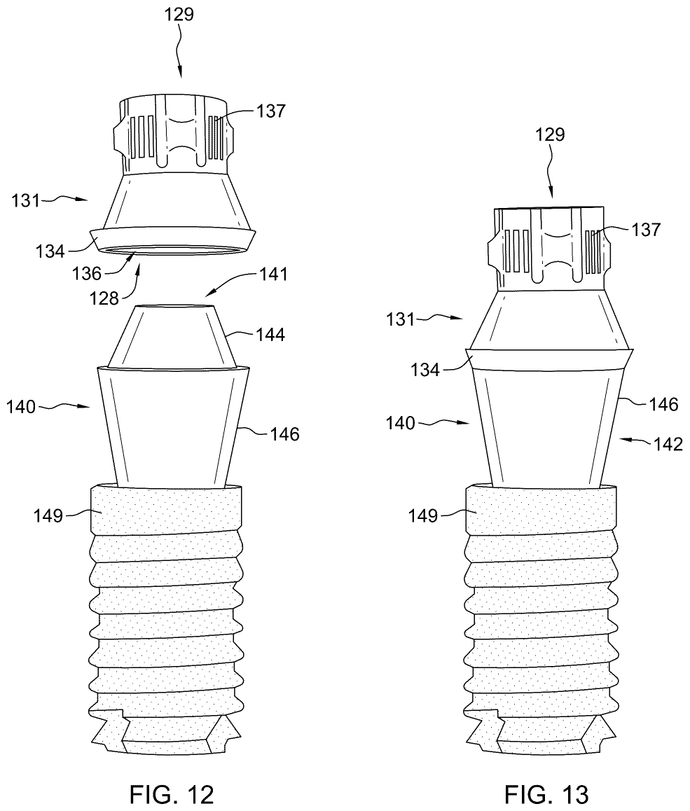

FIG. 11 shows an embodiment of the implant abutment 140 prior to being inserted into a patient and/or the implant base 149 (FIGS. 12-13). The implant abutment 140 may have a first end 141 and a second end 142. The abutment 140 may further include a head portion or protrusion 144, a cavity 145, a shaft portion or anchor portion 146, and/or an attachment means 148. The protrusion 144 may be located at and/or contacting the first end 141 of the abutment 140. In an embodiment, the attachment means 148 may include an extension or protrusion which may be, for example, threaded at the second end 142 of the abutment 140 to facilitate implantation of the abutment 140 into the implant base 149 and/or a mouth of a patient (e.g., in a patient's gingiva and/or jawbone). In some embodiments, the abutment 140 may be implanted directly into the patient's mouth. In other embodiments, the abutment 140 may be connected to the implant base 149 which has been implanted into the patient's mouth. The implant base 149 may therefore be configured to receive the abutment 140 or a plurality thereof.

The cavity 145 may be located at the first end 141 of the abutment 140, for example, within the protrusion 144. The cavity 145 may extend, for example, from the first end 141 into the protrusion 144 and/or the anchor portion 146. The cavity 145 may further be configured and/or sized and shaped to receive a driver or other tool (not shown). When the driver or other tool is inserted into and/or engaged with the cavity 145, the driver or other tool may be twisted, turned and/or rotated to screw the attachment means 148 into the bone and further to secure the attachment means 148 thereto. After the abutment 140 has been secured within the patient's mouth, the cavity 145 may further allow the engagement of a prosthetic screw (not shown) passing through the coping 131 (for example, in a direction from the second end 129 towards the first end 128) to secure the coping 131 to the abutment 140 and thus, to secure the prostheses 130 within the patient's mouth.

As shown in FIGS. 12-13, the protrusion 144 may be configured and/or sized and shaped to be inserted into and/or removably received within the cavity 136 of the implant coping 131. In some embodiments, the abutment 140 and/or the coping 131 may be machine milled from a single solid piece to ensure the protrusion 144 and the cavity 136 are able to achieve the proper engagement (e.g., an intimate surface fit). In other embodiments, the abutment 140 and/or the coping 131 may be cast from metal or made by any other suitable means which allow for the finished components to achieve an intimate surface fit with each other. In an embodiment shown in FIG. 12, the implant coping 131 is depicted prior to engagement with the implant abutment 140. In the example, the coping 131 and the abutment 140 may be oriented such that the first end 128 of the coping 131 faces the first end 141 of the abutment 140. Said another way, the coping 131 and the abutment 140 may be oriented such that the protrusion 144 faces the cavity 136 of the coping 131 and further may be aligned therewith.

FIG. 12 further shows the abutment 140 following engagement with the implant base 149, in which the abutment attachment means 148 has been connected to and/or inserted into the implant base 149. In some embodiments, the implant base 149 may be implanted into the patient's mouth (e.g., in the gingiva and/or the jaw). In such embodiments, the implant base 149 may be in the patient's mouth and the abutment 140 may be connected to the implant base 149 to insert the abutment 140 into the patients mouth. In other embodiments, the abutment 140 may be implanted directly into the patient's mouth.

As shown in FIG. 13, the implant coping 131 may be permanently or reversibly engaged with the implant abutment 140 through the protrusion 144 being received within the cavity 136. In some embodiments, the protrusion 144 may be removably received in the cavity 136, whereas in other embodiments, the protrusion may be permanently received in the cavity 136. In the example, when the protrusion 144 is received within the cavity 136, the rim 134 of the coping 131 may contact and/or engage with the abutment 140, and the inner surface 132 of the coping 131 may contact and/or engage with the protrusion 144. Once such an engagement has been achieved, a prosthetic screw (not shown) may pass through the coping 131 (for example, in a direction from the second end 129 towards the first end 128) and into the cavity 145 to secure the implant coping 131 to the abutment 140.

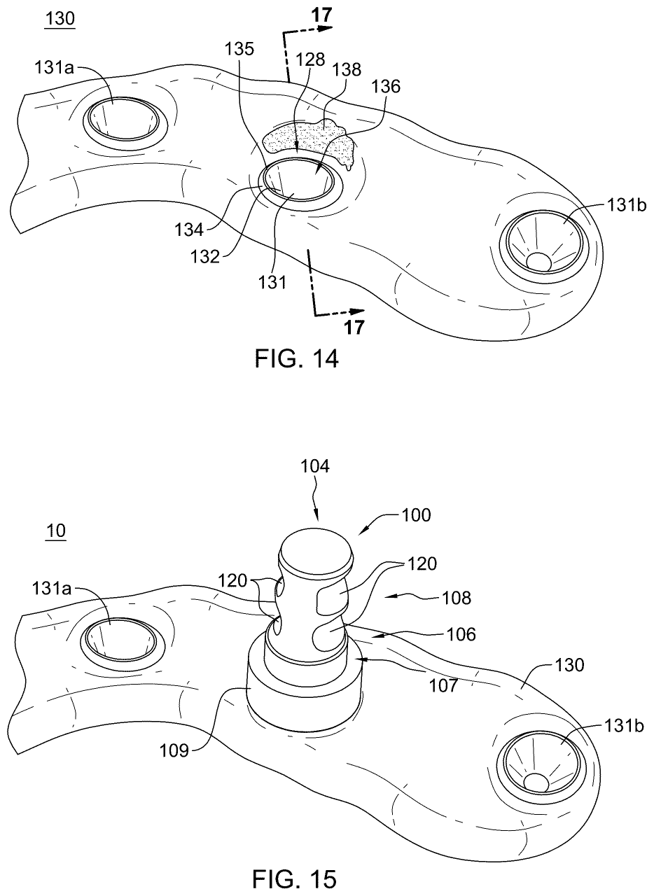

Referring now to FIGS. 14-17 which depict an aspect of the system 10 in operation. FIG. 14 shows the implant coping 131 after the anchor portion 137 thereof has been inserted and/or embedded into the prosthesis 130 up to the rim 134. FIGS. 14-17 show the interior surface of the prosthesis 130. The interior surface of prosthesis 130 may also be the interior surface of prostheses 230, 332, 334, which are described in greater detail below. In the example, there is excess material 138 (e.g., acrylic resin or “flash”) contacting the coping 131. The excess material 138 may be, for example, a leftover excess of an adhesive which was used during the manufacturing process of the prosthesis 130 to secure the coping 131 within the prosthesis 130. Alternatively, or in addition, the excess material 138 may be a portion of the prosthesis 130 material. The excess material 138 may prevent and/or obstruct a desired connection between the coping 131 and the abutment 140 as described above and therefore removal of the excess material 138 may be desirable and/or necessary for the patient to be able to use the prosthesis 130 as intended.

FIG. 17 shows a cross-sectional view of the instrument 100 being inserted into the cavity 136 of the coping 131 of the prosthesis 130. In the example, the tip 110 may be oriented towards the opening 135 of the cavity 136, and the second portion 108 of the instrument 100 may be oriented away from the coping 131 and/or the prosthesis 130. To insert the instrument 100 into the coping 131, the tip 110 of the instrument 100 may be moved towards the cavity 136 until the smooth outer surface 111 of the tip contacts and/or engages the inner surface 132 of the coping 131, and/or until the rim 134 of the coping 131 contacts and/or engages the lip 112 of the instrument 100, and/or until the cutting surface 109 engages and/or contacts the excess material 138.

FIG. 15 shows the instrument 100 in position to remove the excess material 138 from the prosthesis 130 and the coping 131. In the example, the tip 110 (not visible) of the instrument 100 may be received in the cavity 136 of the coping 131 as described above, such that the smooth outer surface 111 of the tip 110 may contact the inner surface 132 of the coping 130, and such that the rim 134 of the coping 131 may be received within the lip 112 of the tip 110. In such a position, the cutting surface 109 may contact the excess material 138. The instrument 100 may thereafter be twisted, turned, and/or rotated to grind, cut, and/or otherwise remove the excess material 138. For example, the second portion 108 of the instrument 100 may be attached to a rotary tool, such as a drill or powered screwdriver, (not shown), which may then be actuated to supply a rotational motion to the instrument 100. As the rotary tool rotates the instrument 100, the cutting surface 109 may erode, cut, grind, and/or otherwise remove the excess material 138. In some embodiments, operation of the instrument 100 as described may result in removal of only as much excess material 138 is necessary to enable a desired engagement and/or connection between the coping 131 and the implant abutment 140. In other embodiments, operation of the instrument 100 as described may result in removal of all excess material 138 In either case, the coping 131 may be in condition to properly engage with and/or connect to the implant abutment 140 following removal of the excess material 138 using the instrument 100 as described above. After the excess material 138 has been sufficiently removed, the instrument 100 may be removed and/or withdrawn from the coping 131.

The tip 110 may protect the coping 131 during the removal of the excess material 138 by preventing and/or obstructing contact between the coping 131 and the cutting surface 109 during operation of the system 10 (e.g., during a rotation of the instrument 100). The smooth outer surface 111 of the tip 110 may further protect the coping 131 by sliding and/or gliding along the inner surface 132 of the coping 131 during a cutting, grinding and/or otherwise removing of the excess material 138.

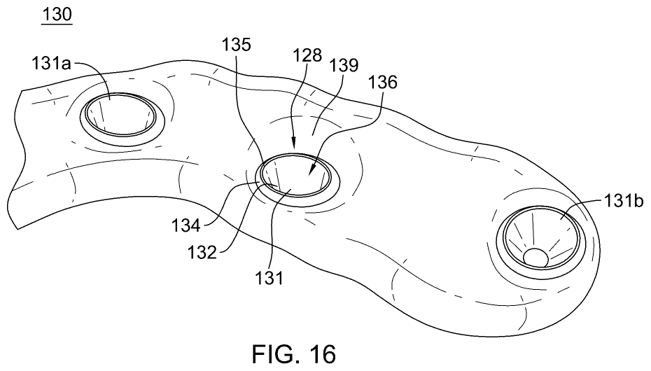

FIG. 16 shows the prosthesis 130 and implant coping 131 of FIGS. 14-15 after the removal and/or withdrawal of the instrument 100 from the implant coping 131 as described above. In the example, the excess material 138 has been removed from the coping 131 leaving behind a clean area 139, such that the remaining excess material 138, if any, may not prevent and/or obstruct the desired connection and/or engagement between the coping 131 and the abutment 140. The coping 131 may thus be in condition to achieve a desired connection and/or engagement with the abutment 140.

In some embodiments, the system 10 may be used to remove only as much of the excess material 138 as may be necessary for the coping 131 to achieve a desired connection and/or engagement with the abutment 140. In other embodiments, the system 10 may be used to remove all of the excess material 138.

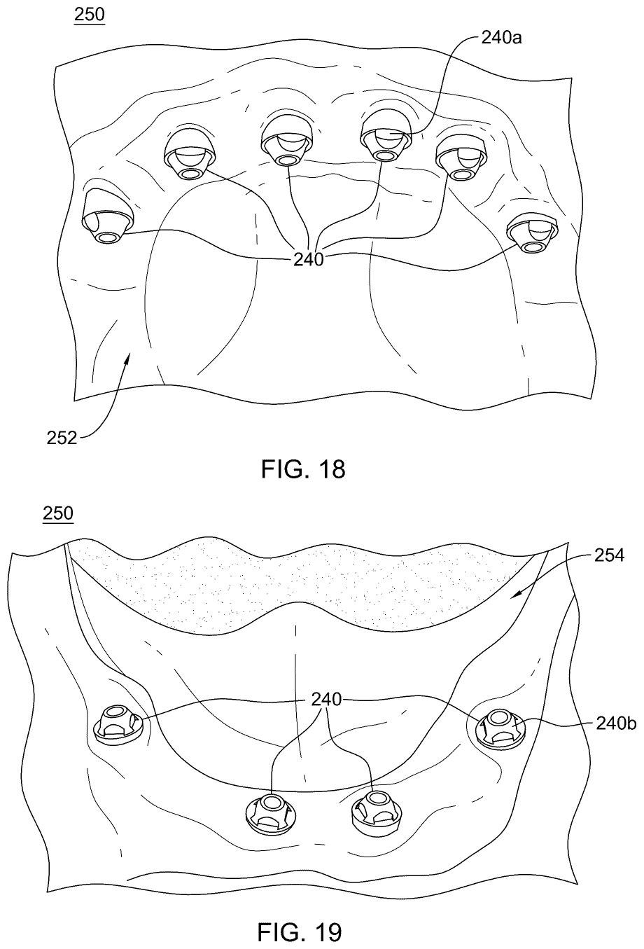

Turning now to FIGS. 18-20, an example of a patient's mouth 250 is shown. FIGS. 18 and 19 depict an upper portion 252 (e.g., jaw and/or gums) of the mouth 250 and a lower portion 254 (e.g., jaw and/or gums) of the mouth 250, respectively, prior to prostheses 230 being inserted therein. As noted above, prostheses 230 may include, for example, the interior surface of prosthesis 130. In the example, a plurality of implant abutments 240 are shown after being connected to an implant base 149 and/or surgically implanted into the mouth 250. The plurality of implant abutments 240 may be, for example, the same or similar to the implant abutments 140, as described in greater detail above and which will not be described again here for brevity's sake. Each abutment of the plurality of implant abutments 240 may thus have an anchor portion 146 which may be secured within the mouth 250, such as in the implant base 149, the gingiva, gums, jaw and/or bone of the upper portion 252 and/or lower portion 254, and thus not visible in the figures. Further, each of the plurality of implant abutments 240 may include a protrusion 144 configured to be received in a corresponding implant coping on the prostheses 230.

In the example shown in FIGS. 18-19, the plurality of implant abutments 240 in the upper portion 252 may include at least one first implant abutment 240a, and the plurality of implant abutments 240 in the lower portion 254 may include at least one second implant abutment 240b. Depending on the embodiment and/or on patient-specific factors (e.g., the dimensions of a patient's mouth and/or jaw), the plurality of implant abutments 240 may include more or less implant abutments in the upper portion 252 and/or the lower portion 254.

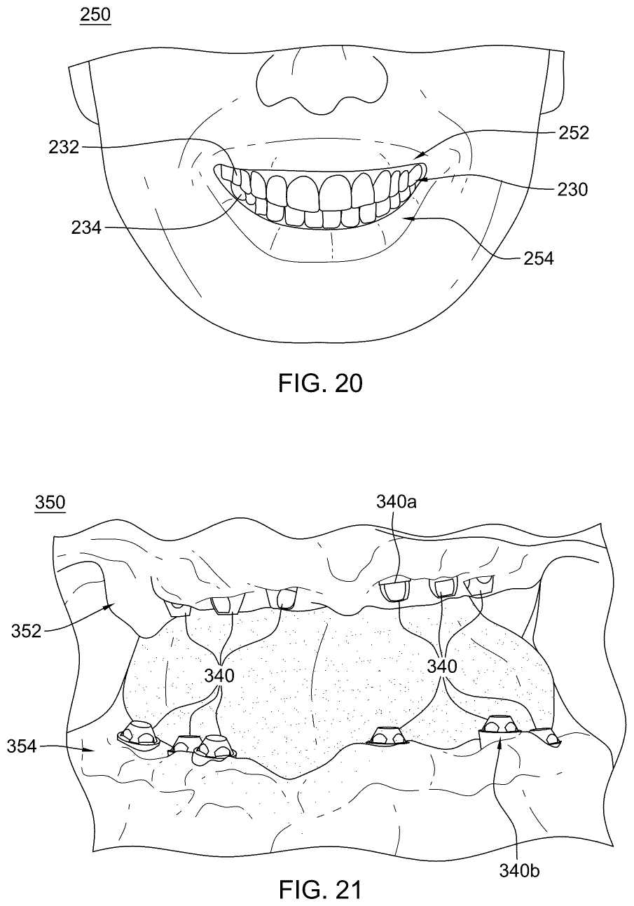

Following implantation of the implant base 149 and/or the plurality of implant abutments 240, the mouth 250 may be in condition to receive the prostheses 230. The prosthesis 230 may include an upper prosthesis 232 configured to be inserted and/or engage the implant abutments 240 in the upper portion 252 (e.g., in the jaw and/or gums) and a lower prosthesis 234 configured to be inserted and/or engage the implant abutments 240 in the lower portion 254 (e g., in the jaw and/or gums), as shown in FIG. 20. Said another way, once the plurality of implant abutments 240 are implanted (e.g., directly into the patient's mouth and/or into the implant base 149), the prostheses 230 may be inserted into the mouth 250. To facilitate the insertion of the prostheses 230 such that a desired engagement between the prostheses 230 and the mouth 250 is achieved, each abutment of the plurality of implant abutments 240 may be aligned with and/or configured to be received in a corresponding implant coping 131 positioned on the interior side of the prostheses 230. Each of the implant copings 131 (not shown in FIG. 20) of the prosthesis 230 may further be prepared through operation of the system 10, as described above, to permit the desired engagement between the implant copings 131 of the prostheses 230 and the implant abutments 240 to be achieved. For example, the first implant abutment 240a may be aligned with and/or configured to be received in a cavity 136 of a corresponding implant coping 131 on the upper prosthesis 232 during an insertion of the upper prosthesis 232 into the upper portion 252. Similarly, the second implant abutment 240b may be aligned with and/or configured to be received in another cavity 136 of another corresponding implant coping 131 on the lower prosthesis 234 during an insertion of the lower prosthesis 234 into the lower portion 254.

The alignment between each of the plurality of implant abutments 240 and each of the plurality of implant copings 131 (not shown in FIG. 20) on the prosthesis 230 may permit the desired engagement therebetween to secure the prostheses 230 within the mouth 250, as shown in FIG. 20. FIG. 20 thus depicts the mouth 250 following proper insertion of the prostheses 230 therein. If the desired engagement between the plurality of implant abutments 240 and the implant copings 131 of the prostheses 230 is not achieved by the insertion of the prostheses 230 into the mouth 250, for example, due to the presence of excess material 138, the prostheses 230 may further be prepared through operation of the system 10 as described above. The prostheses 230 may then be reinserted into the mouth 250 after having the excess material removed.

FIGS. 21-23 show another example of a patient's mouth 350. FIG. 21 shows both an upper portion 352 (e.g., the jaw and/or gums) of the mouth 350 and a lower portion 354 (e.g., the jaw and/or gums) of the mouth 350 prior to prostheses 332, 334, respectively, being inserted therein. In the example, a plurality of implant abutments 340 are shown after being connected to an implant base 149 and/or after being surgically implanted into the mouth 350. The implant abutments 340 may be, for example, the same or similar to the plurality of the implant abutment 140, which are described in greater detail above and which will not be described again here for brevity's sake. Each abutment 340 of the plurality of implant abutments 340 may thus have an anchor portion 146 which may be secured within the implant base 149 and/or the mouth 350, such as in the gingiva and/or the bone of the mouth 350, and thus are not visible in the figures Further, each of the plurality of implant abutments 340 may include a protrusion 144 configured to be received in a corresponding implant coping on the prostheses 332, 334.

In the example shown in FIG. 21, the plurality of implant abutments 340 in the upper portion 352 may include at least one first implant abutment 340a, and the plurality of implant abutments 340 in the lower portion 354 may include at least one second implant abutment 340b. Depending on the embodiment and/or on patient-specific factors (e.g., the dimensions of a patient's mouth and/or jaw), the plurality of implant abutments 340 may include more or less implant abutments in the upper portion 352 and/or the lower portion 354.

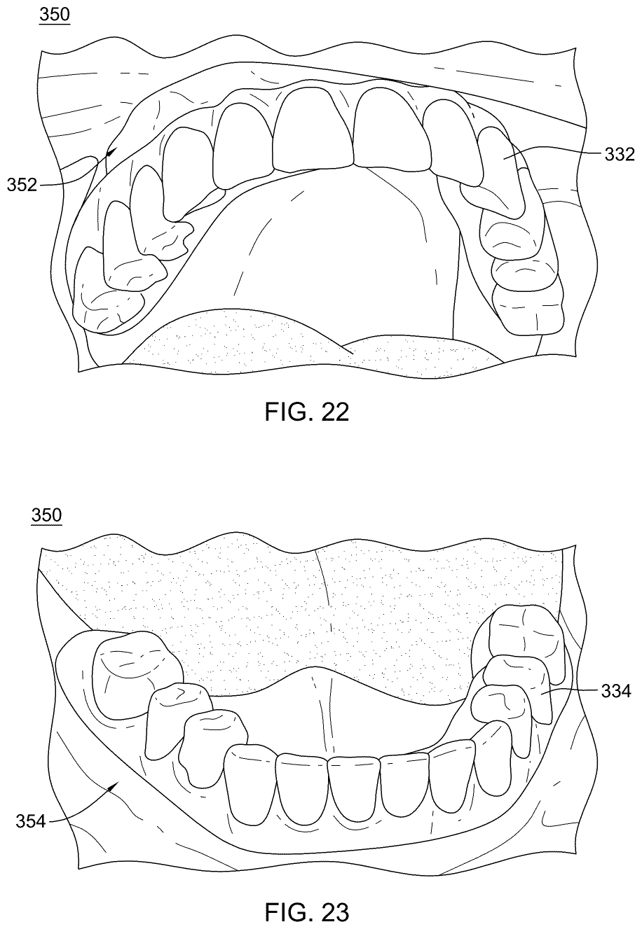

Following insertion and/or implantation of the plurality of implant abutments 340 into the implant base 149 and/or the mouth 350, the mouth 350 may be in condition to receive the prostheses 332, 334. The prostheses 332, 334 may include an upper prosthesis 332 configured to be inserted into the upper portion 352 of the mouth 350, as shown in FIG. 22, and a lower prosthesis 334 configured to be inserted into the lower portion 354 of the mouth 350, as shown in FIG. 23. Said another way, once the plurality of implant abutments 340 are implanted, the prostheses 332, 334 may be inserted into the mouth 350. To facilitate the insertion of the prostheses 332, 334 such that a desired engagement between the prostheses 332, 334 and the mouth 350 is achieved, each abutment 340 of the plurality of implant abutments 340 may be aligned with and/or configured to be received in a corresponding implant coping 131 (not shown in FIGS. 22-23) on the prostheses 332, 334. Each of the implant copings 131 of the prostheses 332, 334 may further be prepared through operation of the system 10 as described above to ensure the desired engagement between the implant copings 131 of the prostheses 332, 334 and the implant abutments 340 is achieved. For example, the first implant abutment 340a may be aligned with and/or configured to be received in a cavity 136 of a corresponding implant coping 131 on the upper prosthesis 332 during an insertion of the upper prosthesis 332 into the upper portion 352 of the mouth 350. Similarly, the second implant abutment 340b may be aligned with and/or configured to be received in another cavity 136 of another corresponding implant coping 131 on the lower prosthesis 334 during an insertion of the lower prosthesis 334 into the lower portion 354 of the mouth 350.

The alignment between each of the plurality of implant abutments 340 and each of the plurality of implant copings 131 on the prostheses 332, 334 may permit the desired engagement therebetween to secure the prostheses 332, 334 within the mouth 350, as shown in FIGS. 22-23. Thus, FIG. 22 depicts the upper portion 352 of the mouth 350 following insertion of the upper prosthesis 332 therein, and FIG. 23 depicts the lower portion 354 of the mouth 350 following insertion of the lower prosthesis 334 therein. If the desired engagement between the plurality of implant abutments 340 and the implant copings 131 of the prostheses 332, 334 is not achieved by the insertion of the prostheses 332, 334 into the mouth 350, for example, due to the presence of excess material 138, the prostheses 332, 334 may further be prepared through operation of the system 10 as described above. The prostheses 332, 334 may then be reinserted into the mouth 350 after having the excess material removed.

As may be recognized by those of ordinary skill in the art based on the teachings herein, numerous changes and modifications may be made to the above-described and other embodiments of the present disclosure without departing from the scope of the disclosure. The components of the methods, systems and/or instruments as disclosed in the specification, including the accompanying abstract and drawings, may be replaced by alternative steps, components or features, such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the implants may include more or fewer components or features than the embodiments as described and illustrated herein. Accordingly, this detailed description of the currently-preferred embodiments is to be taken illustratively, as opposed to limiting the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

What is claimed is:

1. A rotary instrument comprising:
a body with a first end and a second end;
a tip connected to and extending from the first end of the body, wherein the tip has a first end and a second end; and
a protrusion extending circumferentially from an outer surface of at least a portion of the body.

2. The rotary instrument of claim 1, wherein the tip has a truncated cone shape.

3. The rotary instrument of claim 1, wherein the body further comprises:
a first portion and a second portion;
the first portion receiving the protrusion; and
the second portion having at least one cutout in the outer surface of the body and extending from the first portion to the second end.

4. The rotary instrument of claim 3, wherein the second portion further comprises a flat end contacting the second end of the body.

5. The rotary instrument of claim 1, wherein the tip further comprises:
an edge contacting the body; and
a raised lip extending circumferentially along the edge.

6. The rotary instrument of claim 1, wherein the tip further comprises an opening and an aperture, the aperture extending from the opening through at least a portion of the body along an axis extending longitudinally through a center of the body.

7. The rotary instrument of claim 1, wherein the body and the tip are monolithically formed.

8. The rotary instrument of claim 1, wherein tip further comprises a wide end, a narrow end, and a side extending between the narrow end and the wide end;
the side having a first portion and a bevel;
wherein the first portion extends from the wide end to the bevel, and wherein the bevel extends from the first portion to the narrow end.

9. The rotary instrument of claim 1, wherein the protrusion further comprises:
a top surface; and
a side surface, wherein the top surface is connected to the side surface, wherein the top surface extends perpendicular to the body and faces towards the first end, and wherein the side surface extends parallel to the outer surface of the body.

10. The rotary instrument of claim 1, wherein the tip has a smooth outer surface.

11. The rotary instrument of claim 1, wherein the tip and the body are longitudinally aligned along an axis extending through a longitudinal center of the body.

12. A method for preparing a prosthesis for insertion, the method comprising:
obtaining a prosthesis having an implant coping and excess material;
obtaining an instrument having a tip and a first portion;
inserting the tip of the instrument into the implant coping of the prosthesis, such that said tip is received within a cavity of said implant coping, and such that said first portion contacts said excess material; and
rotating said instrument such that said first portion removes at least a portion of said excess material.

13. The method of claim 12, wherein the inserting the tip of the instrument into the implant coping further comprises receiving a rim of the implant coping in a lip of the tip, wherein the tip has a narrow end and a wide end, wherein the lip extends around and contacts the wide end of the tip, and wherein a smooth outer surface of the tip contacts an inner surface of the implant coping; and
wherein the rotating said instrument such that said first portion removes at least a portion of said excess material further comprises avoiding contact between the first portion and the implant coping.

14. The method of claim 12, wherein the rotating said instrument such that said first portion removes at least a portion of said excess material further comprises:
grinding said excess material with an outer surface of said first portion, the outer surface being rough or fluted.

15. The method of claim 12, further comprising:
inserting a second portion of said instrument into a rotary tool and actuating said rotary tool to rotate said instrument.

16. The method of claim 12, wherein the prosthesis further comprises:
a plurality of implant copings, the implant coping being a first implant coping of the plurality of implant copings; and
wherein the method further comprises:
inserting the tip of the instrument into a second implant coping of the plurality of implant copings, such that said tip is received within a cavity of said second implant coping, and such that said first portion contacts said excess material, and rotating said instrument such that said first portion removes at least a portion of said excess material.

17. The method of claim 12, wherein the rotating said instrument such that said first portion removes at least a portion of the excess material further comprises:
rotating said instrument such that said first portion removes enough excess material to permit said implant coping to achieve a desired connection with an implant abutment.

18. A system for preparing a prosthesis for insertion, the system comprising:
an instrument having a tip connected to a body, the body having an outer surface and a removing surface, the removing surface extending along at least a portion of the outer surface of the body; and
a prosthesis having an implant coping and excess material, the excess material contacting the implant coping, and the implant coping having an inner surface;
wherein the tip has a smooth outer surface and is dimensioned to be inserted into the implant coping such that the tip contacts the inner surface;
wherein the removing surface is configured to contact the excess material when the tip is in contact with the inner surface; and
wherein the instrument is configured to be rotated such that the removing surface removes at least a portion of the excess material.

19. The system of claim 18, wherein the implant coping further comprises a rim; and
wherein the tip further comprises a lip extending circumferentially around a wide end of the tip, the lip configured to receive the rim such that the rim avoids contact with the removing surface when the tip is received in the cavity; and
wherein the smooth outer surface of the tip contacts the inner surface of the implant coping when the tip is inserted into the implant coping, and wherein the smooth outer surface of the tip is configured to glide along the inner surface of the implant coping such that the inner surface avoids damage during a rotation of the instrument.

20. The system of claim 18, wherein the instrument further comprises:
an attachment section having at least one cutout configured to be received in a rotary tool, such that actuating the rotary tool results in a rotation of the instrument.
